(19) United States
(12) Patent Application Publication
(10) Pub. No.: US 2003/0085222 A1
(43) Pub. Date: May 8, 2003

(54) Cooking appliance

(76) Inventor: Klaus Erdmann, New Bern, NC (US)

Correspondence Address: LERNER AND GREENBERG, P.A., POST OFFICE BOX 2480, HOLLYWOOD, FL, 33022-2480, US

(21) Appl. No.: 10/261,178

(22) Filed: Sep. 30, 2002

Related U.S. Application Data
(63) Continuation of application No. PCT/EP01/01426, filed on Feb. 9, 2001.

(30) Foreign Application Priority Data
Mar. 29, 2000 (DE) 100 15 746.7

(51) Int. Cl. H05B 6/12

(52) U.S. Cl. 219/620

(57) ABSTRACT

A cooking appliance includes a cooking area containing both a gas burner and an electric heating element. Such a configuration allows a greater output range for cooking heat.

### CROSS-REFERENCE TO RELATED APPLICATION

This application is a continuation of copending International Application No. PCT/EP01/01426, filed Feb. 9, 2001, which designated the United States and was not published in English.

### BACKGROUND OF THE INVENTION

1. Field of the Invention

The invention relates to a cooking appliance containing at least one cooking area with a gas heating device having at least one gas burner whose heating output can be adjusted between a minimum gas heating output and a maximum gas heating output.

European Patent Application 0 485 645 A discloses a gas burner for such a cooking appliance. The disclosed burner has two flame rings disposed coaxially in one another, which can optionally be supplied individually or together with gas to be able to adjust the gas burner between a minimum and a maximum gas heating output. Depending on the adjustment, only the one flame ring or the other flame ring or both flame rings are turned on at the same time or turned off.

Gas cooking appliances have the advantage that their heat is quickly available when they are turned on. However, they have the disadvantage that the gas flames cannot be made arbitrarily small, but that when the quantity of gas supplied falls below a specific minimum quantity, the flame goes out. As a result, the smallest adjustable gas heating output is limited to a value at which the gas flames, although small, just do not go out. For technical reasons, gas burners and gas setting elements are configured for the reliable smallest burner output. As a guideline for the smallest burner output, depending on the gas type, approximately ⅙ of the rated output of the gas burner applies. This means that the smallest possible adjustable gas heating output depends on the maximum possible gas heating output of the burner. It has already been proposed to supply gas in a pulsating manner to the gas burner by an electronic control system in combination with solenoid valves so that the gas flames are turned on and turned off in a pulsating manner.

The smallest possible adjustable gas heating output of approximately ⅙ means that it is 17% of the maximum adjustable gas heating output. The value of 17% is very high as compared with electrical heating devices, in which a minimum electrical heating output is down to only 6% of the maximum electrical heating output, and in the case of electronic control, even only 3% of the maximum electrical heating output.

Therefore, in the case of gas burners, the smallest possible adjustable gas heating output is too high for many cooking operations for cooking foodstuffs, for example, for preparing small quantities of foodstuffs, for melting butter, for keeping meals warm, and the like.

Prior art gas cooking appliances having gas burners with 1, 2, or 3 flame circles give rise to high costs in production and, nevertheless, do not permit an adequately low setting of the gas heating output.

A cooking appliance can be, for example, a cooker, a built-in cooktop or hob with one or more gas burners or a hotplate with one or more cooking areas, of which each cooking area is provided with at least one gas burner. The appliances can be appliances set up individually or built-in appliances.

### SUMMARY OF THE INVENTION

It is accordingly an object of the invention to provide a cooking appliance that overcomes the hereinafore-mentioned disadvantages of the heretofore-known devices of this general type and that, in a constructionally simple and inexpensive manner, provides a cooking appliance having the advantages of a gas heating device and adjustable to a substantially lower heating output than prior art gas cooking appliances.

For such a purpose, a cooking appliance according to the invention is characterized by at least one cooking area having, in addition to the gas heating device, an electric heating device with at least one electric heating element, whose heating output can be adjusted between a minimum electrical heating output and a maximum electrical heating output, and having a minimum electrical heating output lower than a minimum gas heating output.

Without expensive and complicated constructions in a cooking appliance having a cooking area with a gas heating device, the invention permits a reduction in the heating output down to such an extent as is possible in electrical cooking appliances, that is to say, down to about 3% of the maximum adjustable heating output.

The invention can also be used for cooking appliances with very large gas burners, for example, so-called wok burners. The advantage of the invention then manifests itself, in particular, when the cooking appliance has only a single cooking area.

Particularly advantageous embodiments of the invention include:

1. A pan support with integrated electric tubular heating element. The gas burner of such a cooking appliance covers the main output area. The electrical tubular heating element, preferably, has direct contact with the base of a pan that can be placed on the cooking area. The electric tubular heating element can be switched on manually from the smallest adjustment of the gas heating output range. As a result, the gas burner area becomes an electrical cooking area. The heating output may be adjusted and controlled by energy controllers in a conventional manner both during operation as a gas burner area and during operation as an electrical cooking area.

2. A gas burner with integrated electric tubular heating element. Suitable, in particular, for such a purpose are burners that are configured at the same time as pan supports. The tubular heating element can, then, be integrated in the gas burner or fitted to the gas burner.

With the foregoing and other objects in view, there is provided, in accordance with the invention, a cooking appliance, including at least one cooking area having a gas heating device with at least one gas burner having a heating output adjustable between a minimum gas heating output and a maximum gas heating output and an electric heating device with at least one electric heating element having a heating output adjustable between a minimum electrical heating output and a maximum electrical heating output, the minimum electrical heating output being lower than the minimum gas heating output.

In accordance with another feature of the invention, the electric heating element has a supporting surface on which a cooking vessel is to be placed, the supporting surface being a heat transfer surface. Preferably, the cooking vessel is a pot or a pan.

In accordance with a further feature of the invention, the electric heating device has a pan support and the pan support carries the electric heating element. Preferably, the electric heating element is integrated with the pan support as an integrated electric heating element and pan support.

In accordance with an added feature of the invention, the electric heating element surrounds the gas burner.

In accordance with an additional feature of the invention, the gas burner carries the electric heating element.

In accordance with yet another feature of the invention, the electric heating element is integrated with the gas burner, preferably, as a single unit, in particular, a single integrated electric and gas heating element.

In accordance with yet a further feature of the invention, the integrated electric heating element and gas burner has a heat transfer and supporting surface on which a cooking vessel is to be placed.

In accordance with yet an added feature of the invention, there is provided a manually actuatable operating element connected to the gas heating device and to the electric heating device and respectively adjusting a heating output of each of the gas heating device and the electric heating device, preferably, adjusting a heating output of both of the gas heating device and the electric heating device. Preferably, the operating element is a single, manually actuatable operating element adjusting a heating output of both of the gas heating device and the electric heating device.

In accordance with yet an additional feature of the invention, the operating element has a defined movement path with a gas adjustment range for the gas heating device and an electrical adjustment range for the electric heating device, the gas adjustment range and the electrical adjustment range are disposed one after another on the movement path, a minimum gas heating output position in the movement path is adjacent to a maximum electrical heating output position in the movement path, and the operating element switches the gas heating device and the electric heating device from a maximum electrical heating output to a minimum gas heating output and vice-versa.

In accordance with again another feature of the invention, there are provided two manually actuatable operating elements each connected to one of the gas heating device and the electric heating device and each respectively adjusting a heating output of the gas heating device and the electric heating device.

In accordance with again a further feature of the invention, a first of the operating elements has a defined movement path with a gas adjustment range for the gas heating device and a second of the operating elements has a defined movement path with an electrical adjustment range for the electric heating device.

With the objects of the invention in view, in a cooking appliance having at least one a cooking area, there is also provided a heating unit including a gas heating device with at least one gas burner having a heating output adjustable between a minimum gas heating output and a maximum gas heating output, an electric heating device with at least one electric heating element having a heating output adjustable between a minimum electrical heating output and a maximum electrical heating output, the minimum electrical heating output being lower than the minimum gas heating output, and the gas heating device being integrated with the electric heating device in a single unit.

With the objects of the invention in view, there is also provided a heating unit for a cooking appliance, including a gas heating device with at least one gas burner having a heating output adjustable between a minimum gas heating output and a maximum gas heating output, an electric heating device with at least one electric heating element having a heating output adjustable between a minimum electrical heating output and a maximum electrical heating output, the minimum electrical heating output being lower than the minimum gas heating output, and the gas heating device being integrated with the electric heating device in a single unit.

Other features that are considered as characteristic for the invention are set forth in the appended claims.

Although the invention is illustrated and described herein as embodied in a cooking appliance, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF TH DRAWINGS

FIG. 1 is a fragmentary, plan elevational view of a cooking area of a cooking appliance according to the invention;

FIG. 2 is a fragmentary, cross-sectional view of the appliance of FIG. 1 through section line II-II;

FIG. 3 is a fragmentary, diagrammatic, front elevational view of the appliance of FIG. 1 with a manual adjusting element for adjusting the heating output;

FIG. 4 is a graph illustrating heating output as a function of a rotational angle of the manual adjusting element of FIG. 3;

FIG. 5 is a fragmentary, plan elevational view of an alternative embodiment of the cooking appliance of FIG. 1;

FIG. 6 is a fragmentary, cross-sectional view of the cooking appliance of FIG. 5 through section line VI-VI;

FIG. 7 is a fragmentary, plan elevational view of another alternative embodiment of the cooking appliance of FIG. 1; and

FIG. 8 is a fragmentary, cross-sectional view of the cooking appliance of FIG. 7 through section line VIII-VIII.

### DESCRIPTION OF THE PREFERRED EMBODIMENTS

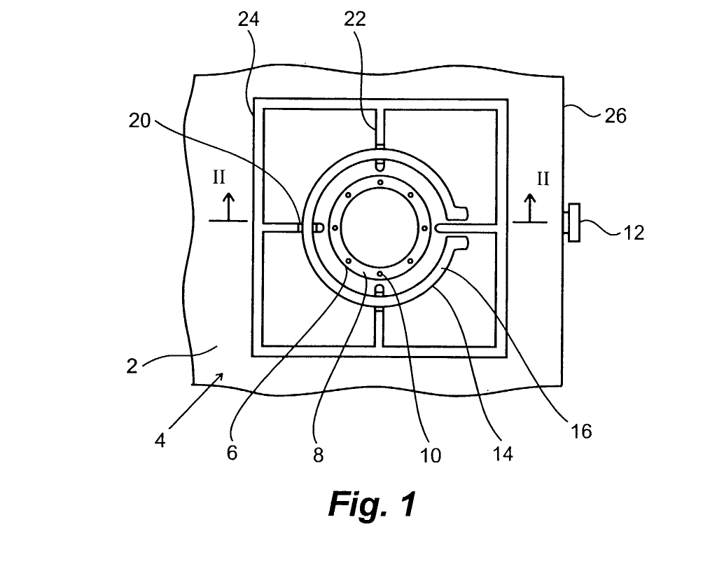

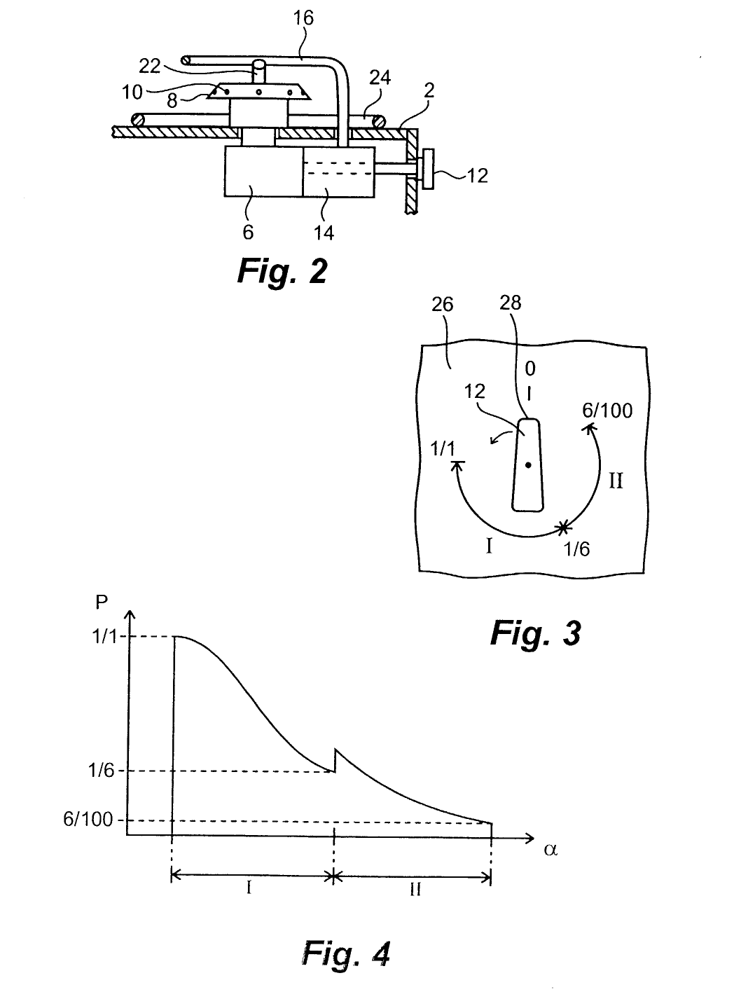

Referring now to the figures of the drawings in detail and first, particularly to FIGS. 1, 2, and 3 thereof, there is shown a cooking appliance 2 according to the invention. The appliance 2 has at least one cooking area 4 with a gas heating device 6 having a gas burner 8 with at least one, preferably, two or more, flame rings which are formed by gas outlet openings 10. The heating output of the gas heating device can be adjusted at a manual adjusting element 12, for example, a rotary knob, between a minimum gas heating output and a maximum gas heating output.

The at least one cooking area 4 has, in addition to the gas heating device 6, that is to say, in addition to the gas burner 8, an electric heating device 14 having at least one electric heating element 16 whose heating output can be adjusted between a minimum electrical heating output and a maximum electrical heating output, the minimum electrical heating output being lower than the minimum gas heating output of the gas heating device 6.

The electric heating element 16, for example, a tubular heating element, surrounds the gas burner 8, for example, in a ring shape, and, preferably, at a constant distance.

The upper surface of the electric heating element 16 is constructed as a heat transfer surface and a supporting surface, on which a vessel in the form of a pot or a pan can be placed to heat or cook foodstuffs and/or beverages.

The electric heating element 16 is inserted into upper depressions 20 in arms 22 of a pan support 24 and is carried by this pan support 24. A vessel that can be put onto the cooking area is, therefore, carried primarily by the pan support 24, while the contact made between the base of the vessel and the electric heating element 16 merely serves for heat transfer to the pan.

According to a modified embodiment, the electric heating element 16 is integrated into the pan support 24.

At the operating element 12, it is possible to adjust manually not only the gas heating output of the gas burner 8 but also the electric heating output of the electric heating element 16. The operating element 12 has a gas adjusting range I marked on the operating panel 26 for the gas heating device 6 with its gas burner 8, and an electrical adjusting range II for the electric heating device 14 with its electric heating element 16. See FIG. 3. The two adjustment ranges I and II are disposed one after another on a defined movement path of a tip 28 of the adjusting element 12. The lowest gas heating output is adjacent the highest electrical heating output. The two adjoin at the point designated “⅙” and, by using the operating element 12, a change can optionally be made from the lowest gas heating output to the highest electrical heating output at the point designated “⅙”. The adjustable highest gas heating output is designated “1/1” at the other end of the gas adjustment range I. The lowest electrical heating output is designated “6/100” at the other end of the electrical adjustment range II.

FIG. 4 shows a graph in which the rotational angle “α” to which the adjusting element 12 can be adjusted is plotted on the horizontal axis. Plotted on the vertical axis of the graph is the heating output “P”. On the horizontal axis, the rotational angle range is divided up into the first adjustment range I of the gas heating output and the second adjustment range II of the electrical heating output. To ignite the gas burner 8, it is adjusted to the highest heating output “1/1” at the adjusting element 12, and its gas flowing out is ignited automatically or manually, depending on the embodiment of the cooking appliance, an automatic igniting device being the preferred embodiment. If the gas heating output is reduced at the operating element 12 beyond the smallest, predetermined adjusting value of “⅙” of the maximum value “1/1”, for example, at this point the gas supply to the gas burner 8 is automatically interrupted and, instead, the electric heating element 16 is switched on, specifically at its highest electrical heating output value. From the highest electrical heating output value, the electrical heating output can be reduced at the operating element 12 down to a predetermined lowest electrical heating output value of, for example, “6/100”. If the heating output is reduced further, the appliance is automatically switched off at the manual operating element 12. Of course, the output range can also be passed through from the absolute lowest electrical heating output value as far as the maximum gas heating output value. In such a case, the ignition of the gas flowing out from the gas burner 8 is not carried out only when the maximum gas heating output value “1/1” is adjusted but, of course, at the transition from electrical heating operation to gas operation, when the adjustment of the lowest possible gas heating output of, for example, “⅙” of the maximum heating output value “1/1” is reached or exceeded.

According to a special embodiment, for a rapid cooking area, an adjustment possibility can be provided to switch on the burner 8 of the gas heating device 6 and the electric heating element 16 of the electric heating device 14 at the same time, in order to produce a heating output greater than the maximum heating output of the gas heating device. Such a possible adjustment can, for example, be provided by the adjusting element 12 having a third rotational area for such a purpose or by being axially displaceable to perform such an adjustment.

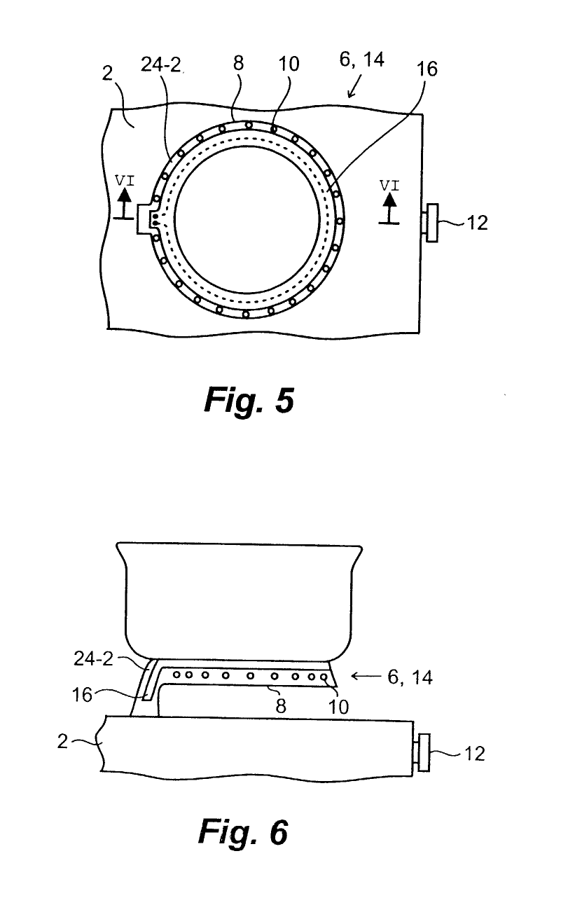

FIGS. 5 and 6 show a cooking appliance according to the invention, in which a gas burner 8 having one or more rings of gas outlet openings 10 and at least one electric heating element 16 are integrated in a pan support 24-2. The heating element 16 can instead also be fixed to the pan support 24-2 instead of being integrated. In both cases, the gas heating device 6 with the gas burner 8, and the electric heating device 14 with the electric heating element 16, together with the pan support 24-2, form one structural unit.

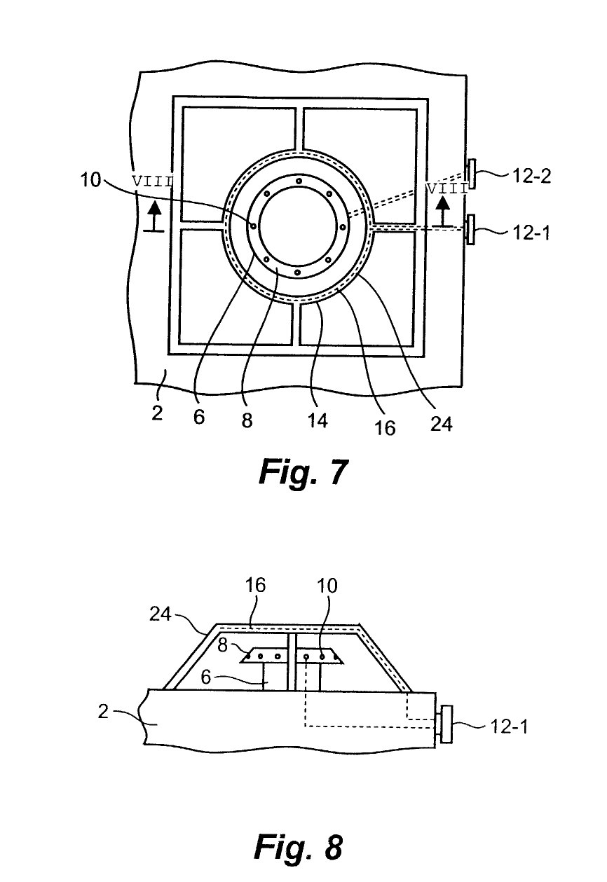

FIGS. 7 and 8 show a further embodiment of the invention, in which the at least one electric heating element 16 is integrated into a pan support 24 and surrounds a gas burner 8 of the gas heating device 6 at a constant distance. The electrical heating output and the gas heating output can be adjustable through the same operating element 12, as in the other embodiments or, as illustrated in FIGS. 7 and 8, by an adjusting element 12-2 for the gas heating device 6 and a further adjusting element 12-1 for the electric heating device 14.

According to the preferred exemplary embodiments, the electric heating element 16 makes contact with the base or a side wall of a vessel that can be placed on the element 16, for example, a pot or pan. According to other embodiments, there may also be spacing between the heating element 16 and the vessel. It is noted, however, that such spacing impairs the heat transfer rate.

I claim:

1. A cooking appliance, comprising:
at least one cooking area having:
a gas heating device with at least one gas burner having a heating output adjustable between a minimum gas heating output and a maximum gas heating output; and
an electric heating device with at least one electric heating element having a heating output adjustable between a minimum electrical heating output and a maximum electrical heating output, said minimum electrical heating output being lower than said minimum gas heating output.

2. The cooking appliance according to claim 1, wherein said electric heating element has a heat transfer and supporting surface on which a cooking vessel is to be placed.

3. The cooking appliance according to claim 2, wherein the cooking vessel is one of a pot and a pan.

4. The cooking appliance according to claim 1, wherein said electric heating element has a supporting surface on which a cooking vessel is to be placed, said supporting surface being a heat transfer surface.

5. The cooking appliance according to claim 4, wherein the cooking vessel is one of a pot and a pan.

6. The cooking appliance according to claim 1, wherein:
said electric heating device has a pan support; and
said pan support carries said electric heating element.

7. The cooking appliance according to claim 1, wherein:
said electric heating device has a pan support; and
said electric heating element is integrated with said pan support.

8. The cooking appliance according to claim 1, wherein said electric heating element is an integrated electric heating element and pan support.

9. The cooking appliance according to claim 1, wherein said electric heating element surrounds said gas burner.

10. The cooking appliance according to claim 6, wherein said electric heating element surrounds said gas burner.

11. The cooking appliance according to claim 7, wherein said electric heating element surrounds said gas burner.

12. The cooking appliance according to claim 8, wherein said electric heating-element surrounds said gas burner.

13. The cooking appliance according to claim 1, wherein said gas burner carries said electric heating element.

14. The cooking appliance according to claim 2, wherein said gas burner carries said electric heating element.

15. The cooking appliance according to claim 4, wherein said gas burner carries said electric heating element.

16. The cooking appliance according to claim 1, wherein said electric heating element is integrated with said gas burner.

17. The cooking appliance according to claim 16, wherein said integrated electric heating element and gas burner has a heat transfer and supporting surface on which a cooking vessel is to be placed.

18. The cooking appliance according to claim 1, wherein said electric heating element is integrated with said gas burner as a single unit.

19. The cooking appliance according to claim 18, wherein said single unit has a heat transfer and supporting surface on which a cooking vessel is to be placed.

20. The cooking appliance according to claim 1, wherein said electric heating element and said gas burner are a single integrated electric and gas heating element.

21. The cooking appliance according to claim 20, wherein said single integrated electric and gas heating element has a heat transfer and supporting surface on which a cooking vessel is to be placed.

22. The cooking appliance according to claim 1, including a manually actuatable operating element connected to said gas heating device and to said electric heating device and respectively adjusting a heating output of each of said gas heating device and said electric heating device.

23. The cooking appliance according to claim 22, wherein:
said operating element has a defined movement path with a gas adjustment range for said gas heating device and an electrical adjustment range for said electric heating device;
said gas adjustment range and said electrical adjustment range are disposed one after another on said movement path;
a minimum gas heating output position in said movement path is adjacent to a maximum electrical heating output position in said movement path; and
said operating element switches said gas heating device and said electric heating device from a maximum electrical heating output to a minimum gas heating output and vice-versa.

24. The cooking appliance according to claim 1, including a manually actuatable operating element adjusting a heating output of both of said gas heating device and said electric heating device.

25. The cooking appliance according to claim 24, wherein:
said operating element has a defined movement path with a gas adjustment range for said gas heating device and an electrical adjustment range for said electric heating device;
said gas adjustment range and said electrical adjustment range are disposed one after another on said movement path;
a minimum gas heating output position in said movement path is adjacent to a maximum electrical heating output position in said movement path; and
said operating element switches said gas heating device and said electric heating device from a maximum electrical heating output to a minimum gas heating output and vice-versa.

26. The cooking appliance according to claim 1, including a single, manually actuatable operating element adjusting a heating output of both of said gas heating device and said electric heating device.

27. The cooking appliance according to claim 26, wherein:
said operating element has a defined movement path with a gas adjustment range for said gas heating device and an electrical adjustment range for said electric heating device;
said gas adjustment range and said electrical adjustment range are disposed one after another on said movement path;
a minimum gas heating output position in said movement path is adjacent to a maximum electrical heating output position in said movement path; and
said operating element switches said gas heating device and said electric heating device from a maximum electrical heating output to a minimum gas heating output and vice-versa.

28. The cooking appliance according to claim 1, including a manually actuatable operating element respectively adjusting a heating output of each of said gas heating device and said electric heating device.

29. The cooking appliance according to claim 28, wherein:
said operating element has a defined movement path with a gas adjustment range for said gas heating device and an electrical adjustment range for said electric heating device;
said gas adjustment range and said electrical adjustment range are disposed one after another on said movement path;
a minimum gas heating output position in said movement path is adjacent to a maximum electrical heating output position in said movement path; and
said operating element switches said gas heating device and said electric heating device from a maximum electrical heating output to a minimum gas heating output and vice-versa.

30. The cooking appliance according to claim 1, including two manually actuatable operating elements each connected to one of said gas heating device and said electric heating device and each respectively adjusting a heating output of said gas heating device and said electric heating device.

31. The cooking appliance according to claim 30, wherein:
a first of said operating elements has a defined movement path with a gas adjustment range for said gas heating device; and
a second of said operating elements has a defined movement path with an electrical adjustment range for said electric heating device.

32. In a cooking appliance having at least one a cooking area, a heating unit comprising:
a gas heating device with at least one gas burner having a heating output adjustable between a minimum gas heating output and a maximum gas heating output;
an electric heating device with at least one electric heating element having a heating output adjustable between a minimum electrical heating output and a maximum electrical heating output, said minimum electrical heating output being lower than said minimum gas heating output; and
said gas heating device being integrated with said electric heating device in a single unit.

33. The cooking appliance according to claim 32, wherein said electric heating element surrounds said gas burner.

34. A heating unit for a cooking appliance, comprising:
a gas heating device with at least one gas burner having a heating output adjustable between a minimum gas heating output and a maximum gas heating output;
an electric heating device with at least one electric heating element having a heating output adjustable between a minimum electrical heating output and a maximum electrical heating output, said minimum electrical heating output being lower than said minimum gas heating output; and
said gas heating device being integrated with said electric heating device in a single unit.

35. The cooking appliance according to claim 34, wherein said electric heating element surrounds said gas burner.
